(19) United States
(12) Patent Application Publication
(10) Pub. No.: US 2024/0037025 A1
(43) Pub. Date: Feb. 1, 2024

(54) ARITHMETIC PROCESSING APPARATUS AND ARITHMETIC PROCESSING METHOD

(71) Applicant: Fujitsu Limited, Kawasaki-shi (JP)

(72) Inventor: Munenori MAEDA, Yokohama (JP)

(73) Assignee: Fujitsu Limited, Kawasaki-shi (JP)

(21) Appl. No.: 18/191,930

(22) Filed: Mar. 29, 2023

(30) Foreign Application Priority Data
Jul. 26, 2022 (JP) 2022-118978

(51) Int. Cl. G06F 12/02; G06F 12/0815

(52) U.S. Cl. CPC G06F 12/023; G06F 12/0815

(57) ABSTRACT

An arithmetic processing apparatus includes: a memory; and a processor coupled to the memory and configured to: determine whether a critical section is being executed in inter-thread synchronization using read-copy-update, and when determining that the critical section is being executed, perform memory freeing processing or memory reallocation processing, which is executed from a scheduler, by speculative execution.

### CROSS-REFERENCE TO RELATED APPLICATION

This application is based upon and claims the benefit of priority of the prior Japanese Patent Application No. 2022-118978, filed on Jul. 26, 2022, the entire contents of which are incorporated herein by reference.

### FIELD

The embodiment discussed herein is related to an arithmetic processing unit and an arithmetic processing method.

### BACKGROUND

As a technique capable of performing synchronization between threads with low overhead, there is read-copy-update (RCU) employed in a Linux (registered trademark) operating system (OS) and the like.

Japanese Laid-open Patent Publication No. 2003-323415 and Japanese Laid-open Patent Publication No. 2011-44161 are disclosed as related art.

### SUMMARY

According to an aspect of the embodiments, an arithmetic processing apparatus includes: a memory; and a processor coupled to the memory and configured to: determine whether a critical section is being executed in inter-thread synchronization using read-copy-update, and when determining that the critical section is being executed, perform memory freeing processing or memory reallocation processing, which is executed from a scheduler, by speculative execution.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram exemplifying a Writer-side pseudo code used in RCU;

FIG. 2 is a diagram for explaining GP advancing countermeasures in RCU;

FIG. 3 is a block diagram schematically illustrating a hardware configuration example of an arithmetic processing unit according to an embodiment;

FIG. 4 is a block diagram schematically illustrating a configuration example of a processor and a memory illustrated in FIG. 3;

FIG. 5 is a block diagram schematically illustrating a functional configuration example of the arithmetic processing unit illustrated in FIG. 3;

FIG. 6 is a block diagram schematically illustrating a configuration example of a pin-down HTM mechanism illustrated in FIG. 5;

FIG. 7 is a flowchart for explaining interrupt handler processing in a Reader transaction according to the embodiment;

FIG. 8 is a flowchart for explaining ending processing of a critical section in the Reader transaction according to the embodiment;

FIG. 9 is a diagram illustrating a first example of a pseudo code executed in a speculative memory management mechanism illustrated in FIG. 5;

FIG. 10 is a diagram illustrating a second example of the pseudo code executed in the speculative memory management mechanism illustrated in FIG. 5;

FIG. 11 is a diagram for explaining processing in the speculative memory management mechanism illustrated in FIG. 5;

FIG. 12 is a diagram for explaining processing in the speculative memory management mechanism illustrated in FIG. 5;

FIG. 13 is a diagram for explaining processing in the speculative memory management mechanism illustrated in FIG. 5; and

FIG. 14 is a diagram for explaining memory division processing according to a modification example.

### DESCRIPTION OF EMBODIMENTS

As a representative application example of RCU, there is memory freeing and reclamation. When a thread frees a memory, the memory is not freed immediately and the freeing processing is put in a queue of processing of checking that all cores have not accessed the area. The memory is freed after the checking, thereby achieving safe reclamation.

However, in order to check that all cores have not accessed the area, the memory freeing processing has to be put in a freeing waiting queue and waited until a waiting period (grace period (GP)) ends. This means that there is unwanted waiting time in a case where safe freeing is possible before the end of the GP. This may cause memory exhaustion or the like.

According to one aspect, it is an object to shorten the time for synchronization between central processing units (CPUs) using RCU.

### [A] Related Example

RCU is a method in which reading and update (and reclamation) of shared data may be executed in parallel without using a lock.

In RCU, removal and reclamation of old data in update are temporally separated and a waiting period (may also be referred to as a “grace period” (GP)) is set for this purpose. In RCU, it is detected that all Readers (reader-side critical section executers) existing before the start of the N-th GP have been ended, and a procedure for detecting the end of the N-th GP is performed.

Hardware transactional memory (HTM), which is a method for accessing a shared memory, has a synchronization unit called a transaction, and has a transaction start instruction and a transaction end instruction.

A memory write issued in a transaction is held locally in the CPU core, and if the transaction commit succeeds, the memory write is reflected atomically in the main memory.

In a case where transactions conflict with each other, a transaction failure occurs and the writing to the memory held locally in the CPU core is entirely discarded (in other words, the writing is not reflected in the main memory).

A conflict of transactions occurs in a case where write is generated for the same address in different transactions and in a case where read and write are generated for the same address in different transactions.

Addresses used in HTM are managed in units of cache blocks in implementation. Accordingly, a conflict is detected even when the addresses are not exactly the same.

HTM has Read set that holds a read cache block set and Write set that holds a write cache block set.

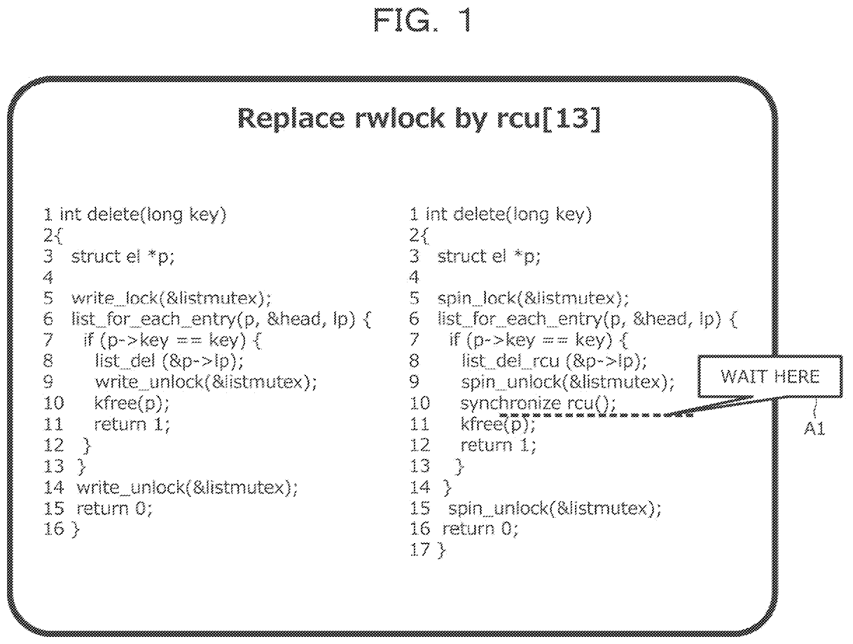

FIG. 1 is a diagram exemplifying a Writer-side pseudo code used in RCU.

In RCU, processing is repeated in which Reader of each core executes a critical section from a stationary state (in other words, a state in which a shared memory is not accessed), and returns to the stationary state when the critical section is ended. Writer waits at synchronize_rcu( )indicated by reference sign A1 until all cores experience the stationary state one or more times.

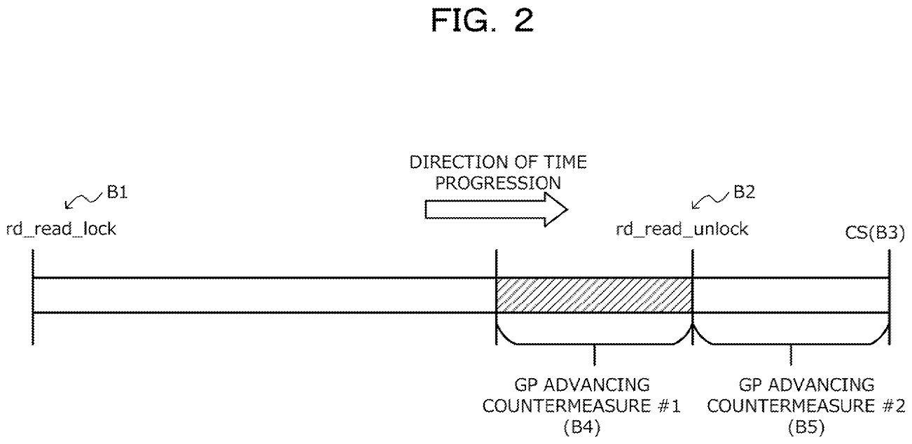

FIG. 2 is a diagram for explaining GP advancing countermeasures in RCU.

A logical critical section of Reader of RCU of each core is a portion sandwiched between rd_read_lock (reference sign B1) and rd_read_unlock (reference sign B2).

At rd_read_unlock, the Writer side and an RCU scheduler are not explicitly notified of the transition to the stationary state. Detection of the stationary state is performed by the RCU scheduler confirming the occurrence of context switching (CS) indicated by reference sign B3, including preemption.

In GP advancing countermeasure #1 indicated by reference sign B4, processing to be described later in the embodiment is executed. On the other hand, GP advancing countermeasure #2 indicated by reference sign B5 is a portion that is logically in the stationary state, but is not treated as the stationary state since CS does not occur.

In GP advancing countermeasure #1, it takes time in the logical critical section (from rd_read_lock to rd_read_unlock) in the first place. When a memory area including a shared variable is freed in this section and reclamation processing proceeds and/or reallocation is performed in different processing, there is no problem until the memory area is actually destroyed by write.

### [B] Embodiment

Hereinafter, an embodiment will be described with reference to the drawings. However, the following embodiment is merely exemplary, and it is not intended to exclude various modification examples or technical applications that are not explicitly described in the embodiment. For example, the present embodiment may be carried out while being variously modified within a scope not departing from the gist of the embodiment. The drawings are not provided with an intention that only the elements illustrated in the drawings are included. Other functions and the like may be included in the drawings. Hereinafter, since the same reference signs in the drawings have similar functions, description thereof may be omitted.

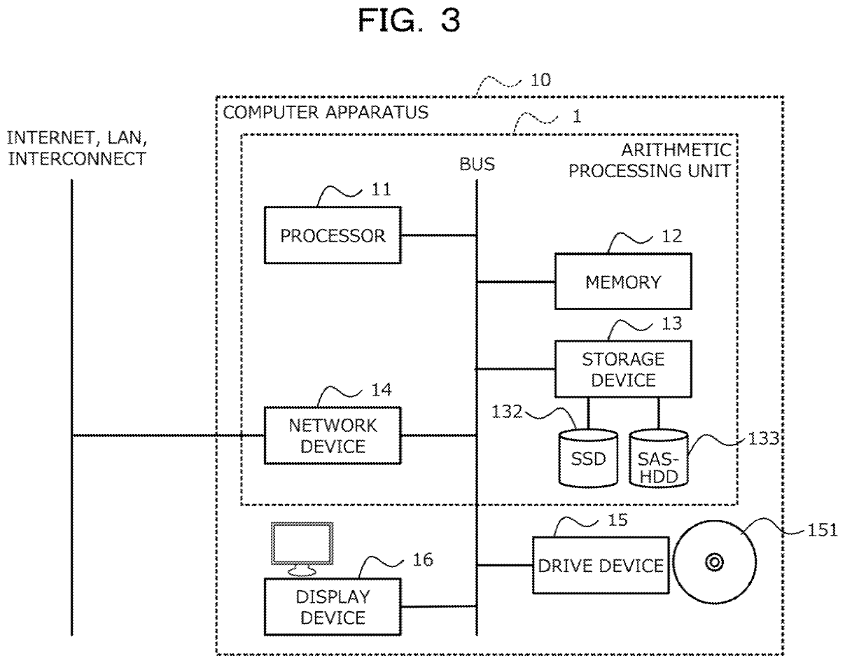

FIG. 3 is a block diagram schematically illustrating a hardware configuration example of an arithmetic processing unit 1 according to the embodiment.

A computer apparatus 10 includes the arithmetic processing unit 1, a drive device 15, and a display device 16.

The arithmetic processing unit 1 includes a processor 11, a memory 12, a storage device 13, and a network device 14. The processor 11, the memory 12, the storage device 13, the network device 14, the drive device 15, and the display device 16 may be communicably coupled to one another via a bus.

The processor 11 is an exemplification of a processing device that performs various kinds of control and arithmetic operation, and implements various functions by executing an OS and a program stored in the memory 12.

For example, the program for implementing various functions may be provided in a form in which the program is recorded in a computer-readable recording medium such as a flexible disk, a compact disc (CD) (such as a CD-read-only memory (CD-ROM), a CD-recordable (CD-R), or a CD-rewritable (CD-RW)), a Digital Versatile Disc (DVD) (such as a DVD-ROM, a DVD-random-access memory (DVD-RAM), a DVD-R, a DVD+R, a DVD-RW, a DVD+RW, or a high definition (HD) DVD), a Blu-ray disc, a magnetic disk, an optical disk or a magneto-optical disk. A computer (the processor 11 in the present embodiment) may read the program from the above-described recording medium through a reading device (not illustrated), and transfer and store the read program to an internal recording device or an external recording device and use the program. For example, the program may be recorded in a storing device (recording medium) such as a magnetic disk, an optical disk, or a magneto-optical disk, and provided from the storing device to the computer via a communication path.

When various functions are implemented, a program stored in an internal storing device (the memory 12 in the present embodiment) may be executed by a computer (the processor 11 in the present embodiment). The computer may read and execute the program recorded in the recording medium.

The processor 11 controls operation of the entire arithmetic processing unit 1. The processor 11 may be a multiprocessor. For example, the processor 11 may be any one of a central processing unit (CPU), a microprocessor unit (MPU), a digital signal processor (DSP), an application-specific integrated circuit (ASIC), a programmable logic device (PLD), and a field-programmable gate array (FPGA). The processor 11 may be a combination of two or more types of elements selected from the CPU, MPU, DSP, ASIC, PLD, and FPGA.

The memory 12 is an exemplification of a storing device that includes a read-only memory (ROM) and a random-access memory (RAM). For example, the RAM may be a dynamic RAM (DRAM). Programs such as a Basic Input/Output System (BIOS) may be written in the ROM of the memory 12. The software program in the memory 12 may be read and executed by the processor 11 as appropriate. The RAM of the memory 12 may be used as a primary recording memory or a working memory.

The storage device 13 is a device that stores data such that the data may be read and written. For example, a serial attached small computer system interface (SCSI) hard disk drive (SAS-HDD) 133, a solid-state drive (SSD) 132, or a storage class memory (SCM) (not illustrated) may be used.

The network device 14 is an interface device for coupling the arithmetic processing unit 1 to a network such as the Internet, a local area network (LAN), or an interconnect, and communicating with an external device (not illustrated) via the network. As the network device 14, for example, various interface cards compatible with a network standard of a wired LAN, a wireless LAN, or a wireless wide area network (WWAN) may be used.

The drive device 15 is configured so that a recording medium 151 may be mounted. The drive device 15 is configured to be able to read information recorded in the recording medium 151 in a state in which the recording medium 151 is mounted. In this example, the recording medium 151 has portability. For example, the recording medium 151 is a flexible disk, an optical disk, a magnetic disk, a magneto-optical disk, a semiconductor memory, or the like.

The display device 16 is a liquid crystal display, an organic light-emitting diode (OLED) display, a cathode ray tube (CRT) display, an electronic paper display, or the like, and displays various kinds of information for an operator or the like. For example, the display device 16 may be combined with an input device (not illustrated), and may be a touch panel.

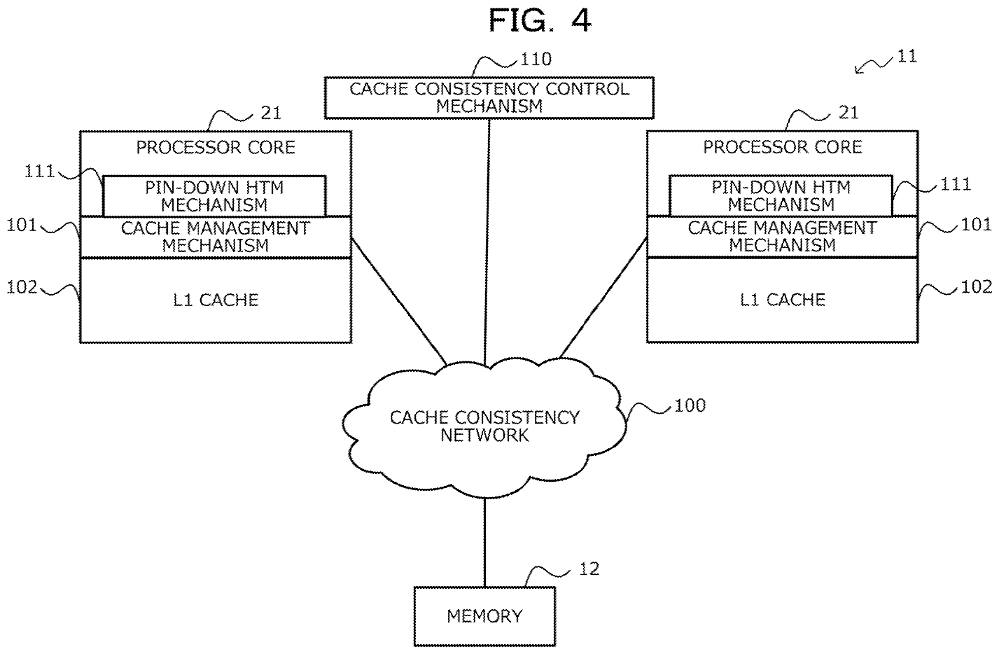

FIG. 4 is a block diagram schematically illustrating a configuration example of the processor 11 and the memory 12 illustrated in FIG. 3.

The processor 11 includes a plurality of sets (two sets in the example illustrated in FIG. 4) of a processor core 21, a cache management mechanism 101, and an L1 cache 102. The processor core 21 may include a pin-down HTM mechanism 111.

The sets of the processor core 21, the cache management mechanism 101, and the L1 cache 102 are coupled to the memory 12 and a cache consistency control mechanism 110 via a cache consistency network 100. The cache consistency control mechanism 110 controls consistency between the L1 caches 102 via the cache consistency network 100.

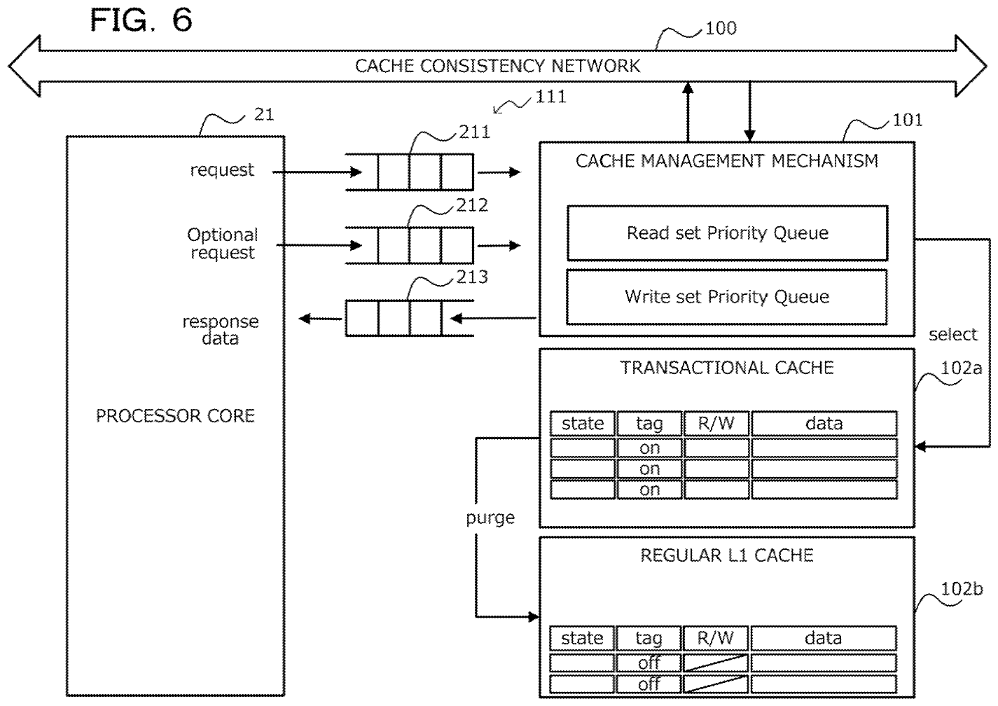

The pin-down HTM mechanism 111, the cache management mechanism 101, and the L1 cache 102 will be described later with reference to FIG. 6 and the like.

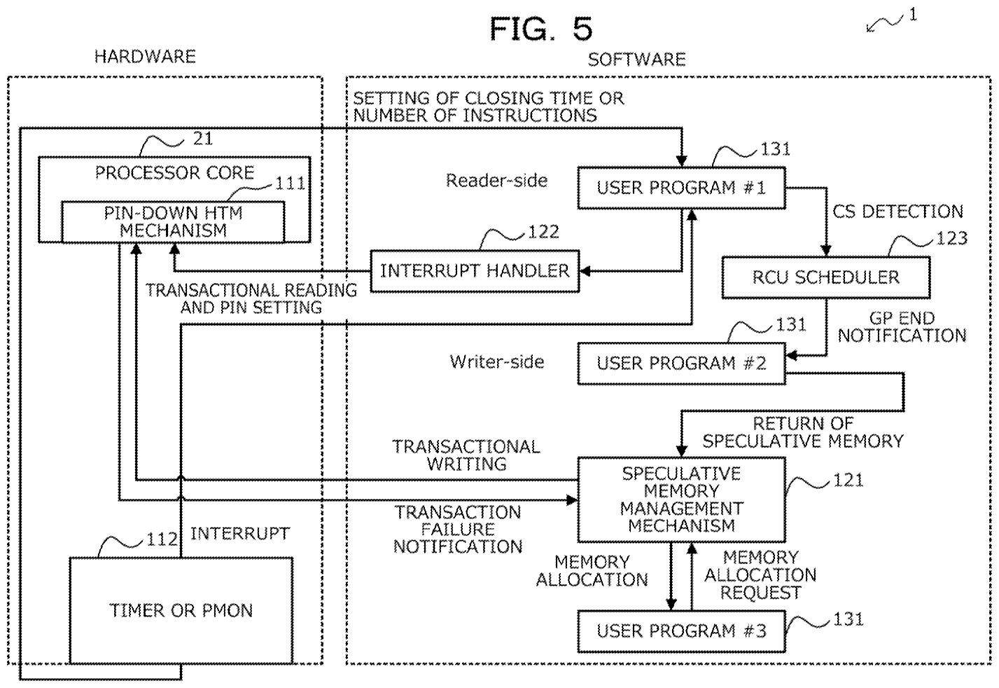

FIG. 5 is a block diagram schematically illustrating a functional configuration example of the arithmetic processing unit 1 illustrated in FIG. 3.

For example, the arithmetic processing unit 1 includes, as hardware, the processor core 21 including the pin-down HTM mechanism 111 and a timer (or a performance monitoring mechanism (PMOM)) 112.

For example, the arithmetic processing unit 1 includes, as software, a speculative memory management mechanism 121, an interrupt handler 122, and an RCU scheduler 123. For example, the arithmetic processing unit 1 executes user programs 131 (user programs #1 to #3) as software.

The timer (or PMON) 112 performs setting of a closing time or the number of instructions for the Reader-side user program #1.

The timer (or PMON) 112 makes an interrupt to the user program #1.

The interrupt handler 122 performs transactional reading and pin setting for the pin-down HTM mechanism 111 with respect to the user program #1.

The interrupt handler 122 determines whether a critical section is being executed in inter-thread synchronization using RCU.

The RCU scheduler 123 performs CS detection from the user program #1, and performs GP end notification for the Writer-side user program #2.

The speculative memory management mechanism 121 accepts return of a speculative memory from the user program #2.

The speculative memory management mechanism 121 performs transactional writing for the pin-down HTM mechanism 111, and receives a transaction failure notification from the pin-down HTM mechanism 111.

The speculative memory management mechanism 121 receives a memory allocation request from the user program #3, and performs memory allocation to the user program #3.

When it is determined that a critical section is being executed, the speculative memory management mechanism 121 performs memory freeing processing or memory reallocation processing, which is executed from the RCU scheduler 123, by speculative execution.

When it is determined that a critical section is being executed and that the start of the critical section is before a waiting period (GP), the speculative memory management mechanism 121 may perform the memory freeing processing or the memory reallocation processing.

In a case where the memory freeing processing or the memory reallocation processing is not safe, the speculative memory management mechanism 121 may cause a transaction conflict to occur and cause the memory reallocation processing to be retried.

FIG. 6 is a block diagram schematically illustrating a configuration example of the pin-down HTM mechanism 111 illustrated in FIG. 5.

HTM is capable of referring to a memory of a plurality of addresses without leaking memory rewriting to the outside when a conflict is detected, and a requester-win policy is implemented in which a requester of a cache block wins a conflict when the conflict occurs. For these reasons, in the present embodiment, HTM is used in the processor core 21.

It is desirable to avoid a transaction failure even when entry purge occurs due to an increase in Read Set and Write Set. It is desirable to protect a specific address from being purged by setting the specific address as a high priority, and to detect a conflict with the specific address without fail. For these reasons, HTM extension is performed in the present embodiment.

Normally, Read Set and Write Set are implemented on hardware, and the resource size is fixed.

Accordingly, the pin-down HTM mechanism 111 may separately include priority queues 211 to 213 such as those as illustrated in FIG. 6 so that priority is set for cache blocks and the cache block of the lowest priority is purged when the cache blocks overflow. In the example illustrated in FIG. 6, the priority queues 211 to 213 are allocated respectively to request, Optional request, and response data from the processor core 21.

For memory freeing and reallocation of RCU, the pin-down HTM mechanism 111 reliably detects a transaction conflict between Reader and a memory reallocation mechanism (Updater), and causes only the Updater side to be a transaction failure every time when the conflict occurs.

The pin-down HTM mechanism 111 may include a unit that executes a transaction in the middle of a critical section of Reader, and may include a unit in which the processing of Updater is a transaction and that suspends or retries reallocation in a transaction failure.

When an entry is purged from Write set, the pin-down HTM mechanism 111 turns off the transaction Tag of a cache block and treats the cache block as a normal cache block. If accessed by a transaction, the transaction is caused to fail, and operation such as Write Back/Write Through/Write Combine is performed.

In FIG. 6, the cache management mechanism 101 manages Read set Priority Queue and Write set Priority Queue. The cache management mechanism 101 refers to the cache consistency network 100, selects a record in a transactional cache 102a, and purges the selected record in a regular L1 cache 102b.

In a Reader transaction, a critical section is surrounded by rd_read_lock and rd_read_unlock. In the critical section, interrupts are not all prohibited and the following interrupt by a trip counter is permitted. This depends on the implementation of rd_read_lock( ).

At the beginning of the critical section, a timer interrupt or an interrupt by a trip counter for the number of executed instructions is set (for example, one second or 10\hat{ }9 counts), and the interrupt is enabled. A processor manufactured by Intel (registered trademark) includes performance monitoring controllers called Performance Monitor Counters, which may be used to make an interrupt to a CPU core.

At the end of the critical section, the above interrupt is disabled. By doing so, logic and performance are not affected in a case where the critical section is short.

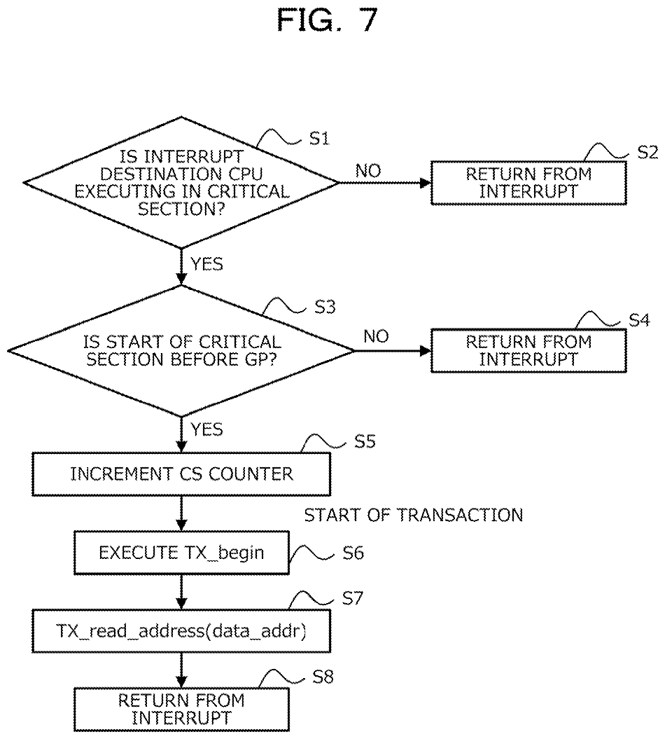

Interrupt handler processing in a Reader transaction according to the embodiment will be described with reference to a flowchart (steps S1 to S8) illustrated in FIG. 7.

The interrupt handler 122 determines whether an interrupt destination CPU is executing in a critical section (step S1).

When the interrupt destination CPU is not executing in the critical section (see NO route in step S1), the processing returns from the interrupt (step S2), and the interrupt handler processing in the Reader transaction ends.

When the interrupt destination CPU is executing in the critical section (see YES route in step S1), the interrupt handler 122 determines whether the start of the critical section is before a GP (step S3).

When the start of the critical section is not before the GP (see NO route in step S3), the processing returns from the interrupt (step S4), and the interrupt handler processing in the Reader transaction ends.

When the start of the critical section is before the GP (see YES route in step S3), the interrupt handler 122 increments a CS counter (step S5).

When the transaction is started, the interrupt handler 122 executes the code of TX_begin (GP advancing countermeasure #1 illustrated in FIG. 2) (step S6). Since a transaction failure does not have to be considered, a fallback address does not have to be designated.

The interrupt handler 122 reads the address destination of the argument for TX_read_address (data_addr), places the address destination in the cache, and overwrites the priority of the cache block with a high priority (step S7). data_addr is the first address of data being currently accessed, which is protected by RCU.

The processing returns from the interrupt (step S8), and the interrupt handler processing in the Reader transaction ends.

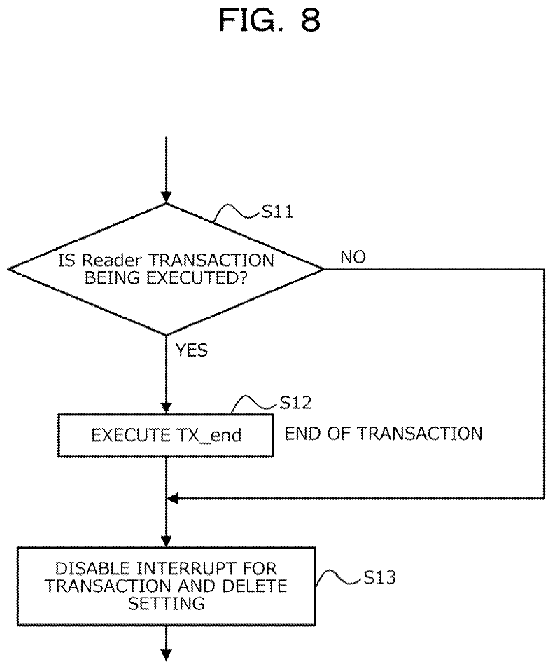

Next, ending processing of the critical section in the Reader transaction according to the embodiment will be described with reference to a flowchart (steps S11 to 513) illustrated in FIG. 8.

The interrupt handler 122 determines whether the Reader transaction is being executed (step S11).

When the Reader transaction is not being executed (see NO route in step S11), the processing proceeds to step 513.

On the other hand, when the Reader transaction is being executed (see YES route in step S11), the interrupt handler 122 ends the transaction and executes the code of TX_end (step S12).

The interrupt handler 122 disables the interrupt for transaction and deletes the setting (step S13). The ending processing of the critical section in the Reader transaction ends.

Processing of an Updater transaction will be described with reference again to the Writer-side pseudo code illustrated in FIG. 1.

Similarly to the Writer-side processing, synchronize_rcu( )returns from the suspended state in response to GPend. GPend is advanced since a part of the CPU core has started the Reader transaction.

kfree receives address p to be freed as an argument, and the address is registered in a management structure for reallocation and allocated by the kmalloc function. Writing to the memory block indicated by p is delayed until the Reader transaction ends. Although a function having the same name as kfree/kmalloc exists in Linux (registered trademark), the function does not depend on the actual implementation of these.

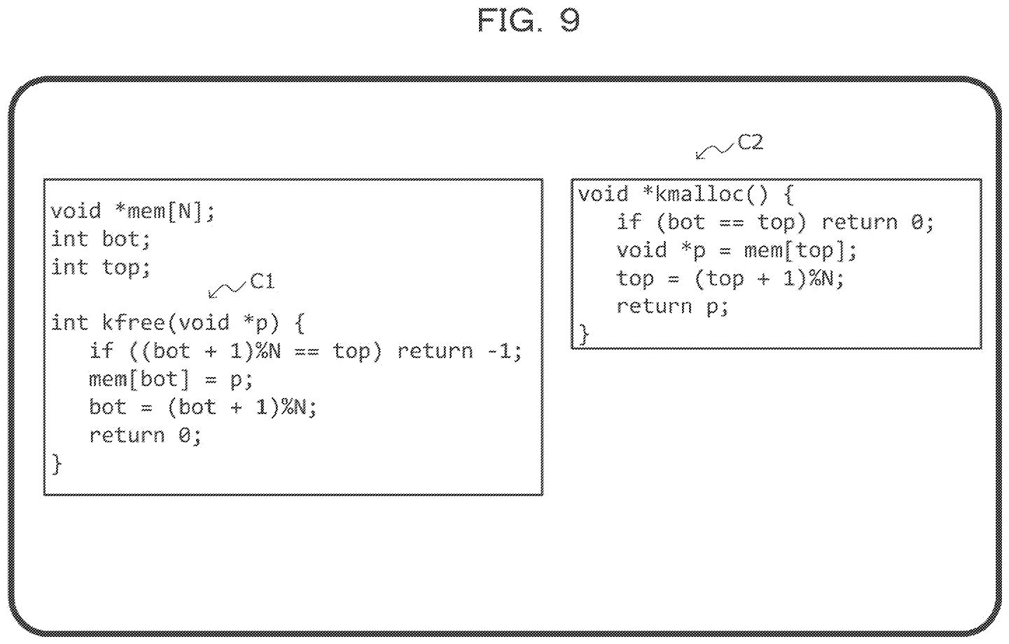

FIG. 9 is a diagram illustrating a first example of a pseudo code executed in the speculative memory management mechanism 121 illustrated in FIG. 5.

A portion to be executed as a transaction in the whole processing of memory freeing, reallocation, and reclamation depends on the implementation of kfree/kmalloc. Hereinafter, a case is disclosed as one embodiment in which the implementation of kfree (reference sign C1) is that a pointer p is stored at the tail of a ring buffer prepared locally in a CPU core, and the implementation of kmalloc (reference sign C2) is that the pointer is taken out from the head of the ring buffer.

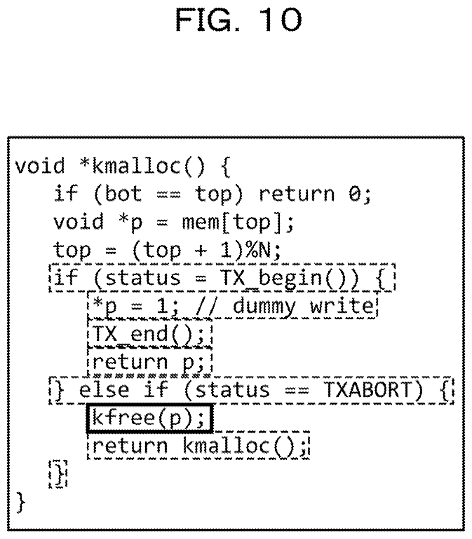

FIG. 10 is a diagram illustrating a second example of the pseudo code executed in the speculative memory management mechanism 121 illustrated in FIG. 5.

Portions surrounded by broken line frames in FIG. 10 are devised points in the present embodiment.

In kmalloc illustrated in FIG. 9, the pointer is taken out from the head of the ring buffer and returned to the caller. On the other hand, in the example illustrated in FIG. 10, the Updater transaction is started and writing is performed to the address indicated by p.

In the Reader transaction, the cache block of address p is entered in readset with high priority before Updater, and the cache block is not purged before the end of the Reader transaction.

The writing to address p (dummy) invalidates the cache block, and when the Reader transaction exists, the Updater transaction is caused to be failure TXABORT.

As a result, p that has once been taken out is moved to the tail of the ring buffer again by calling kfree (thick line frame in FIG. 10).

By recursive calling of kmalloc, only a safe pointer is returned to the caller of kmalloc. A safe pointer is a pointer in which a transaction has succeeded.

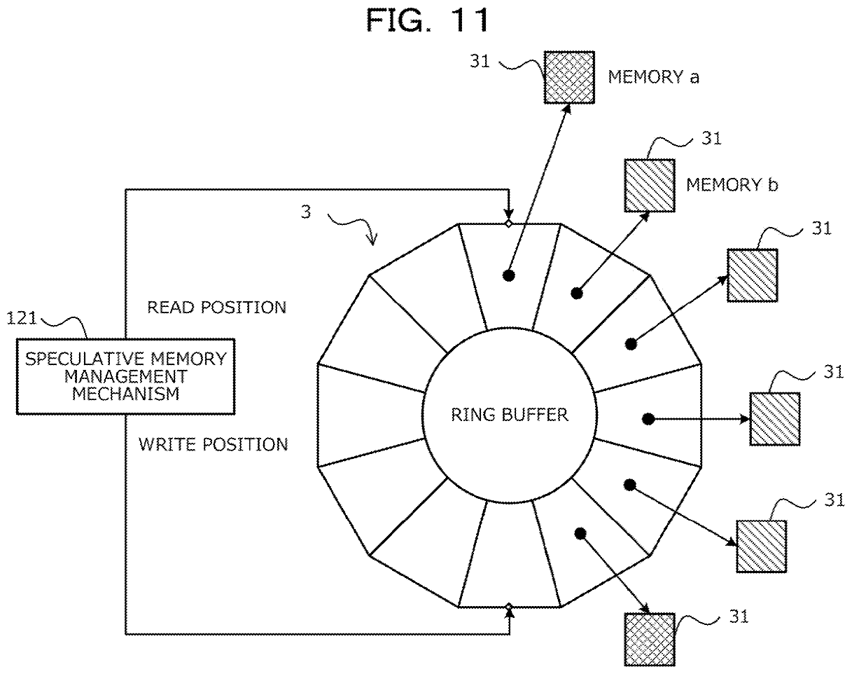

FIGS. 11 to 13 are diagrams for explaining processing in the speculative memory management mechanism 121 illustrated in FIG. 5.

In FIGS. 11 to 13, the speculative memory management mechanism 121 refers to one read position and one write position with respect to a ring buffer 3. In each area of the ring buffer 3, a memory 31 (for example, memory a, b) is allocated or no memory 31 is allocated.

In the example illustrated in FIG. 11, the read position of the speculative memory management mechanism 121 refers to an area where memory a is allocated, and the write position refers to an area where no memory 31 is allocated.

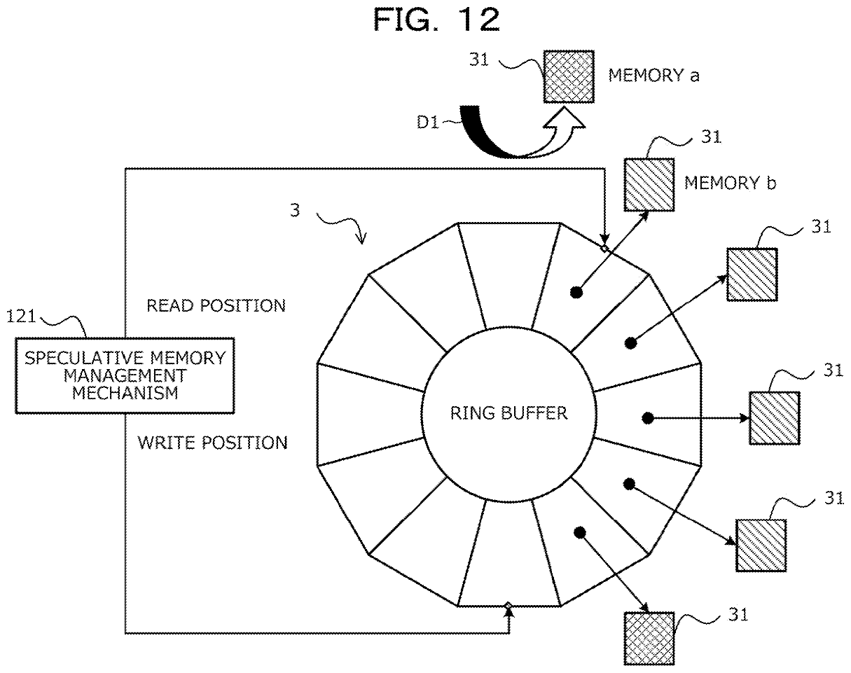

As indicated by reference sign DI. in FIG. 12, in a case where Reader has finished the execution of a critical section for memory a at the time of a memory allocation request, memory a is passed from the ring buffer 3 to the user program #3 illustrated in FIG. 5, and speculative execution is performed. The read position of the speculative memory management mechanism 121 moves to an area where memory b is allocated.

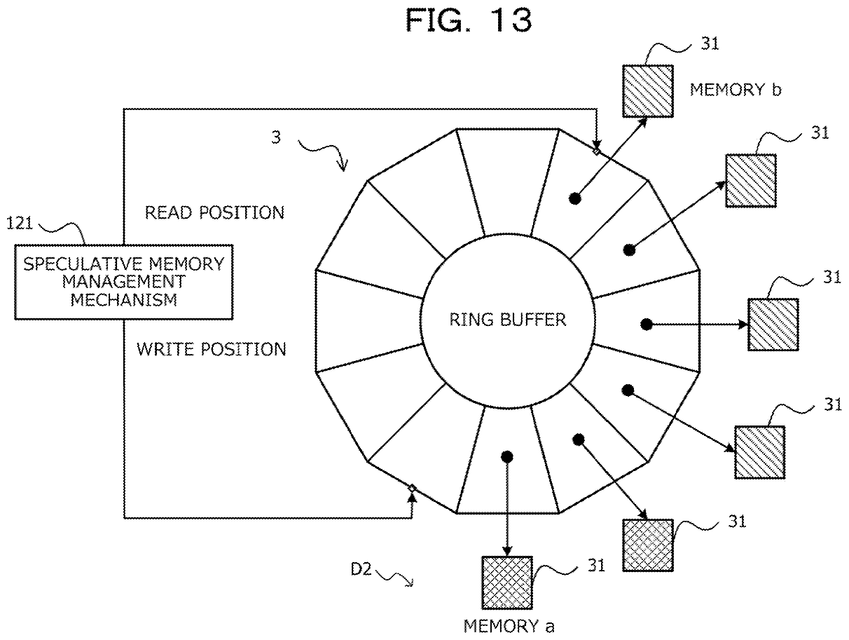

In FIG. 13, in a case where Reader is executing a critical section for memory a at the time of a memory allocation request, the speculative memory management mechanism 121 allocates memory a to the write position of the ring buffer 3.

For example, the dummy writing to memory a causes a speculation failure, and memory a is returned to the tail of the ring buffer 3 by detecting the speculation failure. After that, memory b is recursively allocated and speculatively executed.

The write position of the speculative memory management mechanism 121 moves to an area in the ring buffer 3 where no memory 31 is allocated.

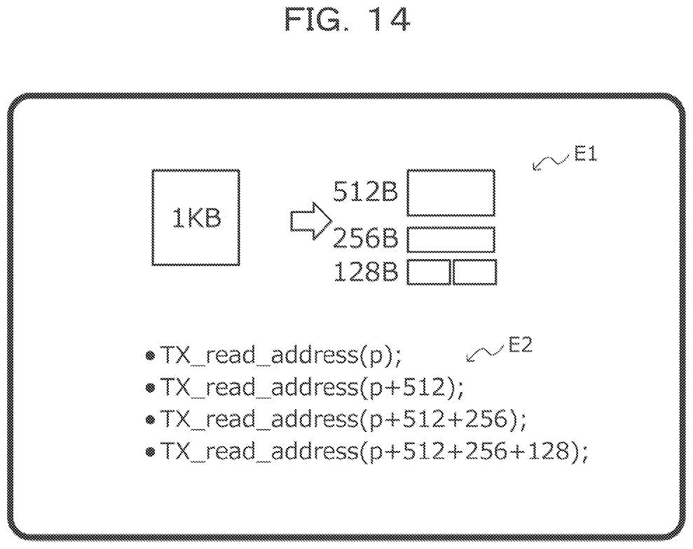

FIG. 14 is a diagram for explaining memory division processing according to a modification example.

In the present modification example, a method in which a memory is divided and reclaimed (segregated memory management) is used.

As indicated by reference sign E1, 1 Kbyte memory is managed by being divided into 512 bytes×1, 256 bytes×1, and 128 bytes×2.

In such a case, as indicated by reference sign E2, TX_read_address( )is called for the divided address. At kfree, TX_read_address is linked to each of the divided lists.

### [C] Effects

According to the arithmetic processing unit and the arithmetic processing method in the embodiment described above, for example, the following action effects may be achieved.

The interrupt handler 122 determines whether a critical section is being executed in inter-thread synchronization using RCU. When it is determined that the critical section is being executed, the speculative memory management mechanism 121 performs memory freeing processing or memory reallocation processing, which is executed from the RCU scheduler 123, by speculative execution.

Accordingly, the time for synchronization between CPUs using RCU may be shortened. For example, an upper limit may be set for a GP section and memory exhaustion may be improved by setting an upper limit to the execution time of a Reader critical section and determining that the critical section has speculatively ended if the critical section has not ended at the time when the execution time has elapsed.

When it is determined that the critical section is being executed and that the start of the critical section is before the waiting period (GP), the speculative memory management mechanism 121 performs the memory freeing processing or the memory reallocation processing.

Accordingly, the memory freeing processing or the memory reallocation processing may be appropriately performed by speculative execution.

In a case where the memory freeing processing or the memory reallocation processing is not safe, the speculative memory management mechanism 121 causes a transaction conflict to occur and causes the memory reallocation processing to be retried.

Accordingly, by checking that the execution of a speculative critical section has ended at the time when the freed memory is reclaimed, the processing of freeing and reclaiming the memory and the execution of the Reader critical section are executed in parallel, the entire execution time is shortened, and safe memory allocation may be ensured.

### [D] Others

The disclosed technique is not limited to the embodiment described above, and may be carried out by variously modifying the technique within a range not departing from the gist of the present embodiment. The configurations and processing in the present embodiment may be employed or omitted as desired or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing apparatus comprising:
a memory; and
a processor coupled to the memory and configured to:
determine whether a critical section is being executed in inter-thread synchronization using read-copy-update, and when determining that the critical section is executed, perform memory freeing processing or memory reallocation processing, which is executed from a scheduler, by speculative execution.

2. The arithmetic processing apparatus according to claim 1,
wherein the processor performs the memory freeing processing or the memory reallocation processing when determining that the critical section is executed and that a start of the critical section is before a waiting period.

3. The arithmetic processing apparatus according to claim 1,
wherein in a case where the memory freeing processing or the memory reallocation processing is not safe, the processor causes a transaction conflict to occur and causes the memory reallocation processing to be retried.

4. An arithmetic processing method comprising:
determining whether a critical section is being executed in inter-thread synchronization using read-copy-update, and when determining that the critical section is executed, performing memory freeing processing or memory reallocation processing, which is executed from a scheduler, by speculative execution.

5. The arithmetic processing method according to claim 4,
wherein the memory freeing processing or the memory reallocation processing is performed when determining that the critical section is executed and that a start of the critical section is before a waiting period.

6. The arithmetic processing method according to claim 4, further comprising:
in a case where the memory freeing processing or the memory reallocation processing is not safe, causing a transaction conflict to occur and causes the memory reallocation processing to be retried.
